(19) United States
(12) Patent Application Publication
(10) Pub. No.: US 2023/0133248 A1
(43) Pub. Date: May 4, 2023

(54) UTILIZATION-SPECIFIC VEHICLE SELECTION AND PARAMETER ADJUSTMENT

(71) Applicant: Capital One Services, LLC, McLean, VA (US)

(72) Inventors: Kana MISHRA, McLean, VA (US); Samuel BAKER, McLean, VA (US)

(73) Assignee: Capital One Services, LLC, McLean, VA (US)

(21) Appl. No.: 17/514,665

(22) Filed: Oct. 29, 2021

(51) Int. Cl. G07C 5/10; G07C 5/08; G06Q 10/00

(52) U.S. Cl. CPC G07C 5/10; G07C 5/0825; G06Q 10/20

(57) ABSTRACT

A method includes obtaining sensor measurements of vehicles to generate vehicle records associated with the vehicles and obtaining a set of vehicle utilization parameters comprising a transportation weight parameter and a navigation path. The method also includes, for each available vehicle of the vehicles, determining vehicle degradation values for the available vehicle based on the set of vehicle utilization parameters, the vehicle record associated with a vehicle category of the available vehicle, and the odometer measurement of the available vehicle. The method also includes selecting a first vehicle over one or more other vehicles of the vehicles based on the vehicle degradation value for the first vehicle and, in response to the selection of the first vehicle, wirelessly providing a destination of the navigation path to an application of the first vehicle.

### BACKGROUND

Vehicles may often be used to perform one or more tasks, such as cargo delivery, transportation, or monitoring. Advances in computing resource availability, sensor technology, and wireless technology have provided significant advances in the control and adjustment of such vehicles. Vehicle-related decisions based on sensor data or other vehicle-related data may be useful for both short-term and long-term vehicle operations.

### SUMMARY

In the context of vehicle fleet control, vehicle selection plays an important role in determining whether tasks are performed. These priorities become increasingly important when managing semi-automated or fully automated vehicles to perform tasks assignable to different vehicles. In theory, the proliferation of vehicle data for individual vehicles may be used to track vehicle performance and ensure that vehicle failure does not interfere with day-to-day operations. However, electrical and mechanical complexity makes the systematic prevention of operation-inhibiting failures a resource-intensive process. In many cases, the failure mode for vehicles may be stochastic, where a vehicle that is functioning within acceptable parameters on the first day may become inoperative on a subsequent day. Furthermore, the operational needs of an organization may change over time, exacerbating the difficulty of vehicle selection and long-term fleet control.

In some embodiments, a system may obtain vehicle sensor measurements or other vehicle-related data for vehicle selection and task management operations to compensate for these complexities, as well as vehicle utilization parameters that characterize one or more tasks or types of tasks a vehicle is allocated to fulfill. The system may then use the utilization parameters, the sensor measurements (obtained from each vehicle), and long-term patterns (obtained from historical vehicle sensor measurements) to predict durations before equipment failure or other degradation values. Based on their corresponding degradation values, the system may filter a set of available vehicles and select a vehicle for a task characterized by the utilization parameters

Various other aspects, features, and advantages of the invention will be apparent through the detailed description of the invention and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and in the claims, the term “or” means “and/or” unless the context clearly dictates otherwise. Additionally, as used in the specification, “a portion,” refers to a part of, or the entirety of (i.e., the entire portion), a given item (e.g., data) unless the context clearly dictates otherwise. Furthermore, a “set” may refer to a singular form or a plural form, such as that a “set of items” may refer to one item or a plurality of items.

### BRIEF DESCRIPTION OF THE DRAWINGS

FIG. 1 shows an illustrative system for facilitating vehicle selection or parameter adjustment for a set of vehicles, in accordance with one or more embodiments.

FIG. 2 shows an illustrative diagram of a system for obtaining data from and adjusting the utilization of a fleet of vehicles, in accordance with one or more embodiments.

FIG. 3 shows a flowchart of a process to determine a set of vehicle characterization parameters, in accordance with one or more embodiments.

FIG. 4 shows a flowchart of a process to predict vehicle events, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention.

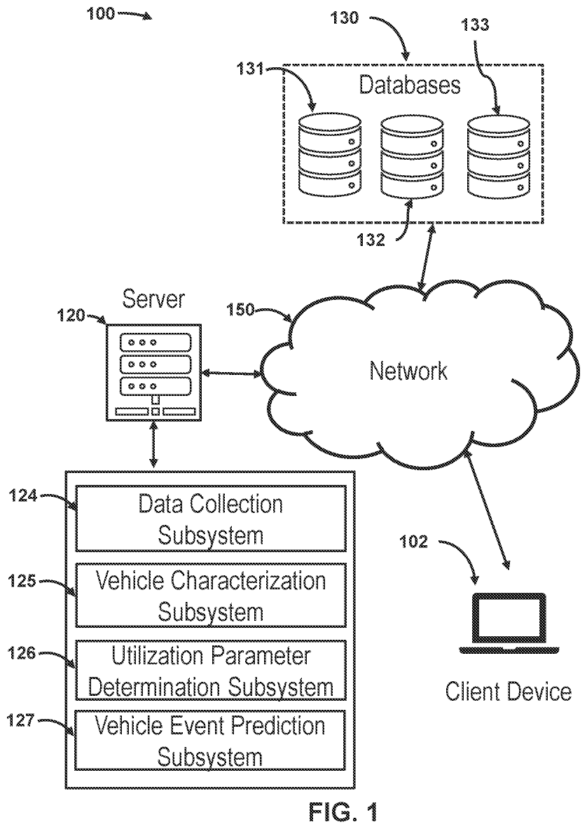

FIG. 1 shows an illustrative system for facilitating vehicle selection or parameter adjustment for a set of vehicles, in accordance with one or more embodiments. A system 100 includes a client computer device 102. While shown as a laptop computer, it should be noted that the client computer device 102 may include other types of computer devices such as a desktop computer, a wearable headset, a smartwatch, another type of mobile computing device, etc. In some embodiments, the client computer device 102 may communicate with various other computer devices via a network 150, where the network 150 may include the Internet, a local area network, a peer-to-peer network, etc.

The client computer device 102 may send and receive messages through the network 150 to communicate with a server 120, where the server 120 may include non-transitory storage medium storing program instructions to perform one or more operations of subsystems 124-127. It should further be noted that, while one or more operations are described herein as being performed by particular components of the system 100, those operations may be performed by other components of the system 100 in some embodiments. For example, one or more operations described in this disclosure as being performed by the server 120 may instead be performed by the client computer device 102. Furthermore, although some embodiments are described herein with respect to statistical models (e.g., time series models or other forecasting models), other prediction models (e.g., a machine learning model) may be used instead of or in addition to the probabilistic learning models. For example, a neural network model may be used to replace a probabilistic model in one or more embodiments to determine a degradation value.

In some embodiments, the set of computer systems and subsystems illustrated in FIG. 1 may include one or more computer devices having or otherwise capable of accessing electronic storage, such as the set of databases 130. The set of databases may store vehicle sensor measurement data, such as odometer measurements, vehicle lidar or radar measurements, vehicle speed measurements, vehicle GPS coordinates, vehicle acceleration/deceleration measurements, images or video data captured by vehicle cameras, temperature sensor measurements, pressure sensor measurements, values obtained from an onboard diagnostic (ODB) system, indications that one or more thresholds are satisfied, etc. Alternatively, or in addition, the set of databases 130 may include other vehicle-related data, such as vehicle sales prices, vehicle accident or incident data, vehicle diagnostic test data, vehicle features available to a vehicle, vehicle features installed/activated on a specific vehicle, etc.

The set of databases 130 may include relational databases (e.g., Microsoft SQL, Amazon RDS™, Oracle database, etc.), graph databases (e.g., Amazon Neptune™ database, Neo4j™, Dgraph™, etc.), or another type database. Some embodiments may also obtain records of datasets or other data not stored in the set of databases 130 by using an application program interface (API) of a third-party data service via the network 150. In some embodiments, different databases of the set of databases may include different types of data. For example, a first database 131 of the set of databases 130 may be a relational database that includes vehicle-specific records that identify vehicles based on VIN and includes records of sales prices, tax prices, and inspections, and one or more identifiers that indicate records stored in a second database 132. A second database 132 of the set of databases 130 may include vehicle-reported sensor data, such as vehicle temperature sensor data, vehicle pressure sensor data, lidar data, radar data, etc. A third database 133 may include learning model parameters associated with different vehicle types or other vehicle characterization parameters. While the set of databases 130 includes three databases 131-133, the set of databases 130 may include other numbers of databases, such as two databases, more than two databases, more than ten databases, more than 50 databases, etc. In some embodiments, the set of databases 130 may be dynamically updated to include more or fewer databases, or data may be redistributed amongst databases of the set of databases 130. Operations described in this disclosure may be performed in response to an update to the set of databases or in response to the data redistribution.

In some embodiments, the client computer device 102 may send messages to the server 120, set of databases 130, or other computer devices via the network 150. The message may include a web request or web response conforming to an established communication protocol (e.g., Hyper Text Transfer Protocol (HTTP), HTTP Secure (HTTPS), etc.). For example, the client computer device 102 may send a query that includes an initial query string to the server 120. The message may be sent during a data session that is characterized by or otherwise associated with a user account. For example, a web request including a set of vehicle utilization parameters or user demographic information may be sent during a first data session to the server 120 while a user is logged into the client computer device 102. A vehicle utilization parameter may include a parameter that characterizes a task to be performed. For example, a vehicle utilization parameter may include a geographic navigation path that a vehicle is to travel, an amount of weight that a vehicle must be capable of transporting, a temperature at which a vehicle must be able to transport cargo, or a set of vehicle features that a vehicle must possess. A set of vehicle features (i.e., “vehicle feature set”) may include various features that a vehicle may possess, such as a maximum number of passengers a vehicle is rated to carry, an engine type, a number of passengers that a vehicle should carry, etc. Some embodiments may then obtain additional information about the user based on user account information associated with the data session while the user is logged in the client computer device 102.

### Subsystems 124-127

In some embodiments, the data collection subsystem 124 may retrieve a set of vehicle records or other vehicle-related data. Some embodiments may obtain session connection information for a database and then perform operations to collect vehicle sensor measurements or other vehicle event data associated with the vehicles. For example, some embodiments may establish a connection with the first database 131 to obtain vehicle sensor measurements and the second database 132 to obtain purchase prices for different vehicles. In some embodiments, the data collection subsystem 124 may obtain data directly from a client computer device, a vehicle, or a third-party data source.

In some embodiments, the data collection subsystem 124 may perform operations to collect the values of vehicle-related data and collect or otherwise sort them based on related categories. For example, some embodiments may obtain vehicle-related data associated with different vehicle categories and generate a set of time series for each vehicle category. A vehicle category may be a category that is usable to represent a shared set of features or other shared properties of different vehicles. Vehicles of a vehicle category may include vehicles that share a vehicle maker, vehicles that share a vehicle manufacturer, vehicles that share a vehicle year of manufacture, vehicles that share a set of vehicle features, a combination of other categories, etc.

After obtaining the vehicle-related data of vehicles associated with a vehicle category, some embodiments may generate a time series based on the vehicle-related data. For example, some embodiments may generate a time series that indicates the resale values for all vehicles associated with the vehicle category “MODEL1” and the manufacture year “2000.” Some embodiments may then collect the set of known purchase prices for each vehicle based on the vehicle age and generate a time series based on the collected data. Alternatively, or in addition, the data collection subsystem 124 may sort or organize vehicle-related data in various other ways. For example, some embodiments may update features of a vehicle by their corresponding categories and associate different vehicle categories in a graph network.

In some embodiments, the vehicle characterization subsystem 125 may be used to characterize a vehicle type with one or more parameters. In some embodiments, a vehicle characterization parameter may be stored in association with a vehicle type. For example, a vehicle characterization parameter may include a prediction model parameter used by one or more prediction models to determine predicted values. As described in this disclosure, a prediction model parameter may include parameters of a statistical model, such as a forecasting model for time series, where a forecasting model may include a moving average model, an exponential smoothing model, a regression model, an autoregressive model, a model combining one or more feature of other models (e.g., moving average autoregressive model), etc. For example, some embodiments may generate an autoregressive model, an integrated model, or a moving average model to predict a vehicle sales price, a probability of engine failure, or another vehicle-related value based on an input, such as vehicle age or distance traveled. For example, the vehicle event prediction subsystem 127 may generate a vector autoregressive model or another multivariate time series to predict a likelihood of equipment failure.

In some embodiments, updating prediction model parameters may include updating learning model parameters, such as the weights, biases, activation function parameters, neuron cell memory gate parameters, etc. As described elsewhere in this disclosure, some embodiments may perform training operations on machine learning models to update one or more prediction model parameters. For example, the vehicle characterization subsystem 125 may obtain a set of learning model parameters from the third database 133 to generate a predicted sequence of probabilities for battery failure for a vehicle based on inputs that include vehicle sensor measurements, utilization parameters, and the set of learning model parameters.

In some embodiments, the utilization parameter determination subsystem 126 may obtain one or more parameters of a set of vehicle utilization parameters from a set of user inputs. Some embodiments may obtain vehicle utilization parameters directly from a user via a user interface. For example, some embodiments may obtain a set of user inputs indicating that a target vehicle must include an exact number of wheels and, in response, update a vehicle utilization parameter to include the number of wheels. Alternatively, or in addition, some embodiments may determine a set of features based on demographic information, location information, or other user-related information. For example, based on a determination that a user is indicated to have three family members and anticipates having two additional family members, some embodiments may add a feature “6+ seats” to a feature set. Furthermore, some embodiments may determine a periodic resource allocation value that represents an amount of a score associated with a user that may be spent to acquire or maintain a vehicle.

Some embodiments may determine a feature set trajectory based on user groups to which a user is assigned. A feature set trajectory may include a plurality of feature sets, where each feature set may include multiple features. For example, a feature set trajectory may include a first feature set associated with a first time point, where the first time point may include a date or specific time of the date, and where the first feature set may include the feature values “4+ seats,” “anti-lock brakes,” and “hybrid.” The feature set trajectory may also include a second feature set that is associated with a second time point, where the second time point may occur after the first time point. For example, the second feature set may include the values “6+ seats,” “electric engine,” and “5G connectivity.”

In some embodiments, the vehicle event prediction subsystem 127 may be used to predict a vehicle event using one or more operations described in this disclosure. A vehicle event may include a mechanical failure event, such as a motor failure or battery failure. For example, some embodiments may use the vehicle event prediction subsystem 127 to determine a probability that a vehicle will suffer a battery failure based on a set of utilization parameters and a set of vehicle characterization parameters. In some embodiments, determining a vehicle event may include determining a vehicle degradation value, where a vehicle degradation value may represent a change in a physical vehicle state or an attribute of a vehicle associated with an increase in vehicle use or vehicle age.

After determining a set of vehicle degradation values associated with a set of vehicles or other values associated with a predicted vehicle event, some embodiments may select a vehicle based on the set vehicle degradation values. For example, after receiving a set of vehicle utilization parameters from the client computer device 102 via an HTTP web request, some embodiments may perform one or more operations described in this disclosure to determine a set of depreciation values. Some embodiments may then select a subset of vehicles from a set of available vehicles based on the set of depreciation values. Some embodiments may then send identifiers and images associated with the selected subset of vehicles to the client computer device 102 for display in a user interface of the client computer device.

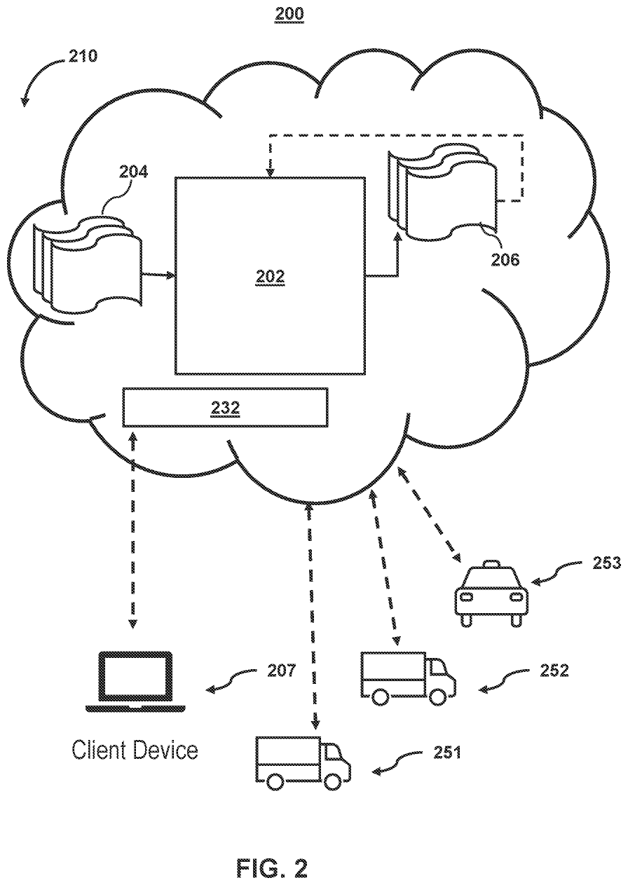

FIG. 2 shows an illustrative diagram of a system for predicting a sequence, in accordance with one or more embodiments. A system 200 may include computer device 207, where the computer device 207 may be any computer device, including, but not limited to, a smartphone, a laptop computer, etc. FIG. 2 also includes cloud computing system 210 implemented on a distributed computer system, where the cloud computing system 210 may include any computing device described in this disclosure or any other type of mobile computer device, fixed computer device, or other computer device. In some embodiments, the distributed computer system may include a set of computing nodes, such as a set of servers or remote computing devices operated by a third party, where the cloud computing system 210 may include a set of programs or computing services being executed by the distributed computer system. In some embodiments, the cloud computing system 210 may perform processor operations or data storage operations similar to or the same as those described elsewhere in this disclosure. For example, the cloud computing system 210 may perform a set of operations performed by the client computer device 102, the server 120, the network 150, or the set of databases 130. For example, the set of databases 130 may each be controlled by different computing nodes of the set of computing nodes, and a query received by the set of databases 130 may cause each node of the set of computing nodes to perform a search based on the query.

In some embodiments, the system 200 may include a set of vehicles, such as a first vehicle 251, a second vehicle 252, and a third vehicle 253. Each of the vehicles 251-253 may include vehicle sensors capable of providing one or more vehicle sensor measurements. Such vehicle sensor measurements may be provided to a computer system, such as a standalone server or the cloud computing system 210. In some embodiments, a user may provide the vehicle sensor measurements via a user interface, such as by typing the measurements into a text box of the user interface. For example, some embodiments may obtain a set of vehicle sensor measurements, such as an odometer reading from a user via a user interface, where the odometer reading may then be sent to the cloud computing system 210 via an HTTP message.

Alternatively, or in addition, some embodiments may receive vehicle sensor measurements directly from a vehicle. For example, the first vehicle 251 may include one or more wireless medication systems that enable the vehicle to communicate with an API of the cloud computing system 210. In some embodiments, the vehicle may communicate with a computer system via a medium-range communication standard, such as a WiFi standard. For example, some embodiments may use an IEEE 802.11p protocol to receive vehicular sensor measurements. Alternatively, or in addition, some embodiments may use a C-V2X standard or 5G-NR standard to send messages to or receive data from vehicles. For example, some embodiments may receive sensor measurements from each of the vehicle 251-253 at a 5G network base station, where the base station may then provide the sensor measurements to the cloud computing system 210.

Some embodiments may use received data, vehicle characterization parameters, and vehicle utilization parameters to determine a set of vehicle degradation values. For example, some embodiments may use sensor measurements of each of the vehicles 251-253 in conjunction with a corresponding set of vehicle sale prices and set of utilization parameters (e.g., a set of navigation paths, a required amount of weight the vehicle must carry or transport, etc.) to determine vehicle depreciation values. Some embodiments may then select a vehicle from a set of available vehicles based on the set of vehicle degradation values. For example, if each of the vehicles 251-253 are indicated as available, some embodiments may select the first vehicle 251 for having the least amount of indicated depreciation based on a computed set of depreciation values. Some embodiments may then perform operations that activate the first vehicle 251 for executing one or more tasks. For example, some embodiments may send a sequence of destinations of a navigation path to the first vehicle that may then cause the first vehicle 251 to travel to each of the sequence of destinations.

In some embodiments, the cloud computing system 210 may include a machine learning model 202. The machine learning model 202 may take inputs 204 and provide outputs 206. The inputs may include multiple datasets, such as a training dataset and a test dataset. An input dataset may include vehicle sensor measurements, such as odometer measurements, acceleration measurements, velocity measurements, engine sensor measurements, or the like. In some embodiments, outputs 206 may be fed back to the machine learning model 202 as input to train the machine learning model 202, where the outputs may be used alone or weighted with user indications of the accuracy of outputs 206. In some embodiments, machine learning model 202 may include an artificial neural network. In such embodiments, machine learning model 202 may include an input layer and one or more hidden layers. Each neural unit of the machine learning model 202 may be connected with many other neural units of the machine learning model 202. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units.

In some embodiments, machine learning model 202 may update its configurations (e.g., by updating weights, biases, or other learning model parameters) based on the outputs 206 and reference feedback information. In some embodiments, where machine learning model 202 is a neural network, connection weights may be adjusted to reconcile differences between the neural network's prediction and reference feedback. For example, an output layer of the machine learning model 202 may output a predicted degradation value. The predicted and known degradation values may be provided to machine learning model 202 during a training operation, where the difference between the predicted and known degradation values may be used to scale a relative or absolute value by which one or more weights, biases, or other model parameters are updated.

In some embodiments, machine learning model 202 may include multiple layers (e.g., where a signal path traverses from front layers to back layers). In some embodiments, the machine learning model 202 may use backpropagation techniques, where forward stimulation is used to reset weights on the “front” neural units. For example, one or more neurons (or cells) of the neural network may require that their respective errors are sent backward through the neural network to facilitate the update process (e.g., backpropagation of error). Updates to the connection weights may be correlated with the magnitude of error propagated backward after a forward pass has been completed, where such updates use various optimization techniques, such as simulated annealing or gradient descent. In this way, for example, the machine learning model 202 may be trained to generate better predictions. In some embodiments, stimulation and inhibition operations for the machine learning model 202 may be more free-flowing, with connections interacting in a more chaotic and complex fashion.

In some embodiments, the system 200 may include an API. In some embodiments, the API layer 232 may reside on one or more components of the cloud computing system 210.

Alternatively, or additionally, the API layer 232 or a portion of the API layer 232 may be implemented on the computer device 207. The system 200 may be partially based on API layer 232 such that there is strong adoption of representational state transfer (REST)ful web services or simple object access protocol (SOAP) web services. Alternatively, system 200 may be fully based on the API layer 232, such that separation of concerns between layers like API layer 232, services, and applications are in place.

In some embodiments, the system architecture of the system 200 may use a microservice approach. For example, some embodiments may include a Front-End Layer and a Back-End Layer where microservices reside. In such an architecture, the API layer 232 may include a middleware component to provide integration between Front-End and Back-End Layers, where the API performs one or more operations described in this disclosure. For example, a middleware component of the API layer 232 may receive an initial query string from the computer device 207 and generate a predicted sequence based on the initial query string. The API layer 232 may use one or more types of communication systems, such as RESTful APIs, an advanced message queuing protocol (e.g., Kafka, RabbitMQ, etc.), gRPC, etc.

### Flowchart

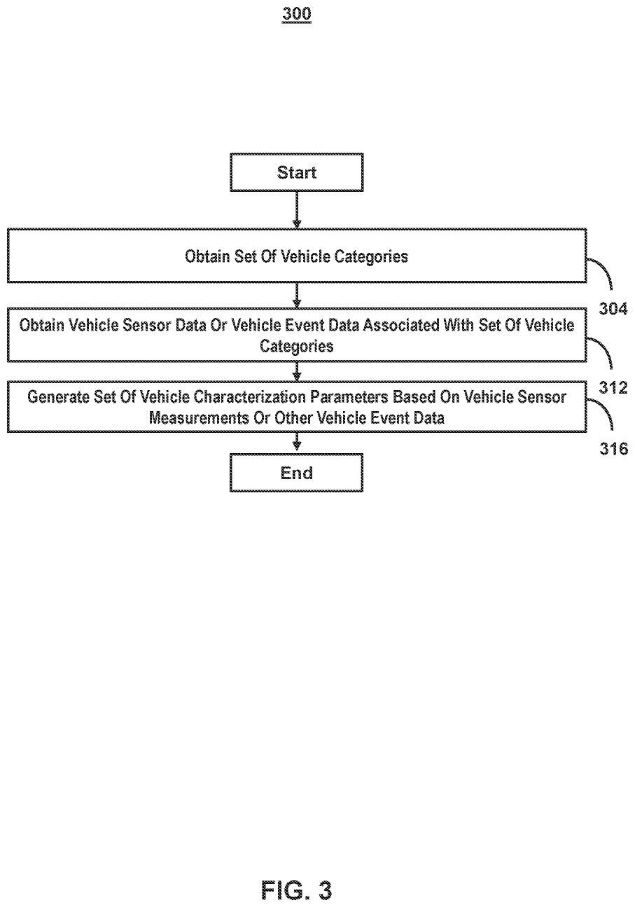

FIG. 3 shows a flowchart of a process 300 to determine a set of vehicle characterization parameters, in accordance with one or more embodiments. Some embodiments may obtain a set of vehicle categories, as indicated by block 304. The set of vehicle identifiers may include vehicle maker identifiers, vehicle model identifiers, identifiers of specific vehicles, etc. Some embodiments may obtain the identifiers from a third-party data source, where the third-party data source may be accessed via an API. In some embodiments, the vehicle identifiers may be used as a vehicle category that is assigned to a plurality of individual vehicles. For example, some embodiments may combine a plurality of vehicle identifiers to form a vehicle category “2022 Maker1 Model1” and then assign the vehicle category to a set of 17 vehicles.

Some embodiments may obtain the set of vehicle categories from a user-provided data or a third-party data source. For example, some embodiments may obtain a set of vehicle categories from a government registry of vehicle manufacturers, vehicle models, or the like. Alternatively, or in addition, some embodiments may obtain vehicle category information directly from a set of vehicles. For example, some embodiments may receive a set of electronic messages from a vehicle and determine whether the set of electronic messages includes identifiers, such as a vehicle manufacturer, a vehicle model, a vehicle manufacture year, etc. Some embodiments may then use one or more of the identifiers as vehicle categories. Furthermore, some embodiments may generate an additional vehicle category based on a shared vehicle feature or combinations of other vehicle categories. For example, some embodiments may determine that multiple vehicles are indicated to include the vehicle feature “5G-enabled” and, in response, update a record or set of records storing vehicle categories with the vehicle category “5G-enabled.”

Some embodiments may obtain vehicle sensor data or vehicle event data associated with the set of vehicle categories, as indicated by block 312. Some embodiments may obtain the odometer measurement or other vehicle sensor measurements of a vehicle directly from the vehicle. For example, some embodiments may receive an odometer measurement from a vehicle via a wireless or wired signal when the vehicle is stationed at a designated fueling or charging location. Similarly, some embodiments may receive other vehicle sensor measurements, such as pressure measurements, temperature measurements, accelerometer measurements, telescopic measurements, etc. For example, some embodiments may receive vehicle temperature measurements, vehicle weight measurements, and vehicle odometer measurements for a trip from a starting location to a destination location of a navigation path.

In some embodiments, the vehicle sensor measurements may include visual or optical data. For example, some embodiments may obtain a set of camera measurements, radar measurements, or lidar measurements from radar or lidar sensors of a vehicle. In some embodiments, the direct measurements made by a camera system, lidar system, or radar system may be provided by a vehicle. Alternatively, or in addition, results computed by an onboard processor of the vehicle or a computer device in communication with the vehicle may be used to determine one or more results, where the one or more results may include indications of vehicle proximity to other objects, vehicle speeds, the density of objects around the vehicle at one or more points in time, etc. For example, some embodiments may receive a set of values representing moments when a lidar system detects that a vehicle is traveling too fast with respect to objects in front of the vehicle.

In addition to obtaining vehicle sensor measurements, some embodiments may obtain other vehicle event data. Vehicle event data may include a sequence of events associated with a vehicle. In some embodiments, the sequence of events may include a log of messages indicating successes, failures, warnings, or other notifications from a device or otherwise associated with the device, where each message may be associated with a timestamp indicating a time and date. For example, a sequence of events of a vehicle may indicate a set of events such as vehicle purchase, vehicle component replacement, vehicle repair, vehicle inspection, vehicle accident, etc.

Some embodiments may determine a portion of a sequence of events based on a written vehicle history or vehicle report generated by a third-party system. For example, some embodiments may obtain a VIN report or maintenance history for a vehicle obtained from a third-party data source. Based on the VIN report or maintenance history, some embodiments may obtain a sequence of events based on a sequence of odometer measurements, a sequence of sales reports, a sequence of ownership reports, or a sequence of insurance reports indicating different types of damage, etc.

Some embodiments may use a machine learning model to generate a set of events based on written data or other data described in this disclosure. For example, some embodiments may determine a set of events based on a maintenance history that includes text written in natural language form by converting the text into a sequence of tokens. Some embodiments may then generate a sequence of embedding vectors based on the sequence of tokens using an encoder-decoder neural network model and then determine an event code of an event sequence based on the sequence of embedding vectors using a transformer neural network. Some embodiments may increase the accuracy of the prediction by using a geographic location associated with the transaction record as an additional input of the transformer neural network or other machine learning model used to determine an event code. Alternatively, or in addition, some embodiments may perform keyword or key-phrase matching, where the presence of a token or sequence of tokens may be mapped to an event code representing a vehicle event. For example, based on a determination that a vehicle report for a vehicle includes the token “collision” in association with a specified date, some embodiments may add an event represented by the event code “coll” in a sequence of events associated with the vehicle.

Some embodiments may refer to data associated with a user record to populate an event of a sequence of events of a vehicle. For example, a vehicle may be associated with a user record that includes a user score. Some embodiments may obtain a transaction record associated with the user record that includes a set of database transactions indicating a corresponding set of changes to the user score. The transaction record may include a date of the transaction, the value of the score change, and a set text associated with the transaction record. In some embodiments, the set of text may include an identifier of a product or service, which may be used as a reference identifier to determine whether the transaction is associated with a vehicle. For example, some embodiments may determine that a text associated with a transaction record includes a product identifier and then send a message including the product identifier to an API of a server. Some embodiments may then receive a response to the message that indicates that the product identifier is compatible with the vehicle or is otherwise associated with the vehicle. In response to a determination that the product identifier is compatible with the vehicle, some embodiments may update a sequence of events associated with the vehicle based on the product or a numeric value associated with the product (e.g., a price of the product).

Some embodiments may randomize or add noise to one or more sensor measurements before storing the sensor measurements in a repository. For example, after obtaining sensor measurements of a vehicle, some embodiments may perform operations that modify the time for which the sensor is measured, modify sensor measurements, or modify other values. Furthermore, some embodiments may modify other values described elsewhere in this disclosure, such as sales prices or maintenance costs. Modifying a value may include increasing or decreasing the value by a randomly or pseudo-randomly generated amount, multiplying by a randomly or pseudo-randomly generated factor, etc. In some embodiments, the modified values may still be used to permit a vehicle associated with the modified values to be selected using one or more operations described in this disclosure.

Some embodiments may generate a set of vehicle characterization parameters based on the vehicle sensor measurements or other vehicle event data, as indicated by block 316. A set of vehicle categorization parameters may be used to determine one or more characterization values of a vehicle. In some embodiments, the set of vehicle characterization parameters may represent or otherwise include parameters of a function used to determine a specific predicted vehicle characterization output. For example, some embodiments may use a set of vehicle characterization parameters that include a set of vectors of a multivariate time series model to predict a vehicle degradation value. In some embodiments, the predicted vehicle characterization output may include a likelihood for equipment failure, a predicted time interval for the equipment failure to occur, a predicted depreciation value, etc. Alternatively, or in addition, the vehicle degradation value may represent other types of values, such as an accident probability, an expected periodic cost, a change in an expected periodic cost, etc.

In some embodiments, the set of vehicle characterization parameters may include a vector of values. For example, some embodiments may generate a vector for a vehicle category. By applying principal component analysis on the measurements and event data for one or more vehicles sharing the vehicle category. For example, some embodiments may obtain a plurality of vehicles sharing a vehicle category, where the vehicle category may include a make and model of vehicles. Some embodiments may then collect each respective odometer measurement, average deceleration thrust, and number of times a lidar distance sensor was triggered from each respective vehicle having a first vehicle category representing a vehicle maker and a second vehicle category representing a vehicle model. Some embodiments may then use principal component analysis or another dimension-reducing operation to determine a set of principal components, where a vehicle characterization parameter may be used in conjunction with the set of principal components to determine a depreciation value. Some embodiments may then store the set of principal components in association with one or more of a set of vehicle categories shared by the plurality of vehicles or may store the set of print components specifically with a combination of the set of vehicle categories. Some embodiments may later compare one or more vectors generated with a principal component analysis (PCA) operation to quickly determine a predicted vehicle characterization output.

Alternatively, or in addition, some embodiments may train a machine learning model based on a set of training input, where the set of vehicle characterization parameters may include learning model parameters of the machine learning model. Various types of machine learning models may be used. For example, some embodiments may use a transformer model to generate a sequence of values, such as a time series. For example, some embodiments may use temporal fusion transformers to generate a time series based on an input. In some embodiments, the temporal fusion transformer may include a first set of connected recurrent neural network cells to determine the most high-impact features of an input, a set of gated recurrent neural networks with skip connections to allow different combinations of inputs to affect a system, and a temporal self-attention model to combine information from different time steps.

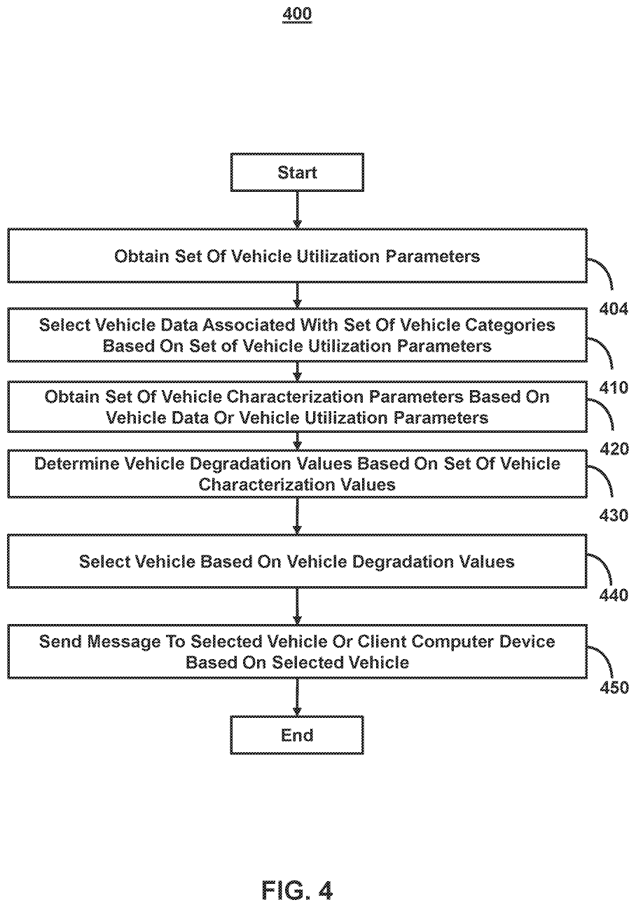

FIG. 4 shows a flowchart of a process 400 to predict vehicle events, in accordance with one or more embodiments. Some embodiments may obtain a set of vehicle utilization parameters, as indicated by block 404. Obtaining the set of vehicle utilization parameters may include obtaining one or more parameters indicating tasks for vehicle use, how to use a vehicle, references to sub-tasks of a task, etc. Some embodiments may obtain the set of vehicle utilization parameters directly. For example, some embodiments may provide a user interface for a vehicle or vehicle fleet management application, where a user may input locations, cargo, passenger identifiers, passenger counts, etc., into a user interface. Alternatively, some embodiments may obtain vehicle utilization parameters by estimating the vehicle utilization parameters based on user inputs. For example, some embodiments may obtain a count of a set of entities (e.g., a household size), a set of locations frequently visited by the user, an occupation type, etc.

Some embodiments may receive the set of user inputs as one or more text values, categories, Boolean values, geolocation coordinates, or other location identifiers, numeric values, or other types of values. A user may provide a set of user inputs via a text entry terminal or an application displaying a graphic user interface on a client-side device, where the set of user inputs may then be used as, or be used to, determine a set of vehicle utilization parameters. Alternatively, or in addition, a set of user input may be obtained from a set of previously stored values or an API that provides data from a third-party data source.

Some embodiments may determine one or more computed values based on the set of user inputs, where the set of vehicle utilization parameters may include the computed values. For example, some embodiments may determine a utilization parameter based on the set of user inputs, where the utilization parameter may indicate an amount of intended resource usage. In some embodiments, a sequence of utilization parameters or another type of plurality of user scores may be generated based on a set of user inputs. For example, some embodiments may obtain a set of user inputs having an indication that the user plans on going on road trips greater than 100 km away from the home three times every year. In response, some embodiments may update a sequence of utilization parameters to correspond with a sequence of time segments in a year-long duration. For example, some embodiments may determine a utilization parameter for each respective time segment of a sequence of six time segments, where three of the six time segments have a utilization parameter equal to a first value, and where the other three of the six time segments have utilization parameters equal to a second value different from the first value. The utilization parameters may represent a distance traveled per day weighted by whether the travel is on a highway or in urban environments, etc.

The set of user inputs may include feature-specific information for a vehicle, such as a desired number of seats, higher safety features, lidar detection, rear facing cameras, self-driving features, cruise control, etc. For example, some embodiments may use a user interface to submit a set of user inputs that includes a set of vehicle features, the set of vehicle features including a target number of seats, an onboard smart computing system, 5G connectivity, etc. As discussed elsewhere in this disclosure, some embodiments may then use the set of features to select a vehicle or a type of vehicle.

In some embodiments, a user may provide a duration when providing the set of user inputs. Providing the duration may include providing a specific period of time for which a user intends to possess a vehicle. Alternatively, some embodiments may predict a duration or otherwise assign a duration for a user's long-term use of a vehicle. For example, some embodiments may determine that a user is assigned to a specific user group and determine that users of the specific user group have an average vehicle ownership of 6 years. In response, some embodiments may assign the duration of 6 years to the user.

The set of user inputs received by a computer system may include user-related information or demographic information from the user. For example, some embodiments may receive a set of inputs that includes an intended ownership duration for a user, a set of entities associated with the user (e.g., a number of family members in a household), and age, an indication that the user is anticipating one or more children, a household size, etc. Furthermore, some embodiments may obtain financial information related to a user, such as a credit score, a debt amount, a daily or monthly spending amount, a measure of user assets, etc. As discussed elsewhere in this disclosure, the user-specific information may be used to determine future utilization parameters, future feature values, a duration, a device usage schedule, etc. Alternatively, or in addition, some embodiments may use the demographic information stored in a user record to determine future utilization parameters for a sequence of utilization parameters. For example, based on a determination that a user record is associated with a first user group using a clustering algorithm, some embodiments may then retrieve a set of predicted utilization parameters for future time segments associated with the first user group.

Some embodiments may select vehicle data associated with a set of vehicle categories based on the set of vehicle utilization parameters, as indicated by block 410. A vehicle category may represent a specific class of vehicle, a model of vehicle, a brand or maker of a vehicle, vehicles having a specific feature or type of feature, etc. For example, a vehicle category may include the category name “Commercial 18-Wheel Truck” to represent the vehicle category for 18-wheel trucks. Alternatively, or in addition, some embodiments may assign multiple vehicle categories to a vehicle record. For example, some embodiments may assign the first vehicle category “MAKER1” to a vehicle record and assign a second vehicle category “MAKER2” to the vehicle record.

Some embodiments may obtain vehicle data stored in a sequential format or reconstruct vehicle data to be stored in a sequential format. For example, some embodiments may retrieve a set of time series of vehicle sensor measurement, where the time series may include a sequence of sensor measurements (e.g., battery degradation measurements, maximum engine temperature, brake degradation measurements, etc.) sorted by vehicle lifespan. Alternatively, or in addition, some embodiments may organize or construct sequential data that sorts vehicle sensor measurements based on other vehicle sensor measurements, such as distance traveled. For example, some embodiments may store a sequence of paired values, where the first value is an indicated vehicle stopping distance and the second value is an odometer measurement. Alternatively, or in addition, a time series or other set of organized data may include other vehicle-related values, such as an indicated selling price or depreciation value. For example, some embodiments may obtain values from vehicle data to construct a time series that indicates the selling price of a vehicle.

Some embodiments may select vehicle data based on vehicle utilization parameters that are directly provided by a user. For example, a user may provide a set of user inputs via a web request that includes a first value representing a vehicle having at least six seats, a second value indicating that the vehicle must have an electric engine, and a third value indicating that the vehicle is to have a radar safety system. After receiving the set of user inputs, some embodiments may search for vehicle data sets storing vehicle records, where the target vehicle records of the search include the vehicle categories “6+ seats,” “electric engine,” and “radar system.” Some embodiments may filter a plurality of sets of model inputs or model outputs for prediction models based on the set of user inputs, as described elsewhere in this disclosure.

Some embodiments may select vehicle data based on vehicle utilization parameters that are computed from a set of user inputs that include demographic data or user-specific scores. For example, some embodiments may obtain a set of locations indicated to have been frequently visited by the user and a home address of the user to determine a set of navigation paths. Various operations may be used to determine the set of navigation paths, where determining the navigation paths may include providing the home destination and the set of other locations to an API, such as the Google Maps™ API, and retrieving the navigation paths provided by the API. For example, some embodiments may provide a first address that is the home address of the user, a second address that is indicated to be the work address of the user, and a third address that is indicated to be the third-most visited location by the user. Some embodiments may then provide the set of locations to a geographic mapping API and receive a set of navigation paths from the first address to the second and third addresses. Based on the navigation paths, some embodiments may then determine vehicle utilization parameters, such as a daily travel time, an accident probability, and anticipated duration of acceleration and deceleration, and anticipated average amount of thrust during acceleration or deceleration, etc.

Furthermore, some embodiments may determine other vehicle utilization parameters, such as a transportation weight parameter. A transportation weight parameter may represent an anticipated amount of weight or a range of weight that a vehicle is required to transport for a vehicle-related task. Some embodiments may predict a transportation weight based on a set of entities associated with a user. For example, some embodiments may receive a set of user inputs indicating that a user has five family members. Some embodiments may then estimate a total weight or a range of weights for the five family members to determine a transportation weight parameter representing the carrying weight or range of carrying weights, respectively. Some embodiments may then use the transportation weight parameter as a utilization parameter. Values associated with vehicle acceleration, deceleration, distance traveled, traffic density, and vehicle carrying weight may significantly impact one or more vehicle characterization outputs. For example, some embodiments may obtain a transportation weight parameter, a daily travel duration, and an estimated number of starts and stops to determine a vehicle degradation value, such as a value that represents a depreciation amount or a likelihood that a component of the vehicle will require replacement.

Some embodiments may then determine one or more categories based on the set of vehicle utilization parameters by determining a set of vehicles classified as suitable for one or more of the vehicle utilization parameters. For example, in response to obtaining a set of vehicle utilization parameters indicating a requirement for target vehicles to carry at least 400 kg of weight at least once per month, some embodiments may choose a first vehicle category having the category name “medium load.” Similarly, in response to obtaining a set of vehicle utilization parameters indicating a requirement for target vehicles to carry at least 4000 kg weight on a daily basis, some embodiments may choose a second vehicle category having the category name “heavy load.”

Some embodiments may predict a feature set for a future time point. For example, some embodiments may determine that a user that falls within a user group or plurality of user groups is likely to obtain a vehicle having a different set of vehicle features within a five-year period. Some embodiments may predict future vehicle feature sets at multiple time points to generate a feature set trajectory, where each feature set of the feature set trajectory corresponds with a different moment or interval of time. For example, some embodiments may determine a feature set trajectory for a user that provided a set of user inputs that indicated a first set of vehicle features. The feature set trajectory may be determined based on a determination that the user is assigned to a first user group “demo1” and that individuals of the group “demo1” are most likely to become individuals of the group “demo2” within two years and are then most likely to become individuals of the group “demo3” within five years. Some embodiments may then determine a second set of vehicle features of vehicles most likely to be obtained by individuals of the group “demo2” for a first time interval corresponding with two years, and then determine a third set of vehicle features of vehicles most likely to be obtained by individuals of the group “demo3” for a second time interval corresponding with five years.

In some embodiments, the user groups may be directly associated with vehicle categories, where the possible groups that the user may be associated with may then be used to determine one or more vehicle categories based on these associations. Alternatively, or in addition, some embodiments may use a feature set trajectory to determine a vehicle category or plurality of vehicle categories. For example, some embodiments may combine a first feature set, a second feature set, and a third feature set of a feature set trajectory to determine a feature superset that includes every feature of the first, second, and third feature sets. Some embodiments may then select one or more vehicle categories, or combination of vehicle categories indicated to satisfy the requirement. Some embodiments may determine a device feature superset based on a first feature set corresponding with a present set of vehicle features provided by a set of user inputs and a second set of vehicle features predicted to be present in a vehicle obtained by the user within the five-year period.

Alternatively, or in addition, some embodiments may determine which of the features of a vehicle feature superset are high-priority features and which features are not high-priority features. For example, some embodiments may obtain a feature set trajectory and a corresponding priority value of features for each feature set. In some embodiments, the priorities associated with vehicle features of vehicles obtained by users of a user group may be determined by user inputs of the users. Alternatively, some embodiments may determine the priority values of vehicle features based on how many of the vehicles obtained by the users include the vehicle feature. For example, a user group may obtain a set of vehicles, where a first subset of the vehicles includes a first feature and a second subset of the vehicles includes a second feature, where the first subset of vehicles has more vehicles than the second subset of vehicles. In response, some embodiments may assign a greater priority value to the first feature in comparison to the second feature. Some embodiments may then select a vehicle type or other vehicle category based on the high-priority features. For example, some embodiments may generate a set of features that includes all the shared features of a plurality of feature sets of a feature set trajectory and also includes the vehicle features indicated as being within the N highest-priorities of their respective feature sets, where N may be an integer greater than zero, greater than one, greater than two, or another integer.

Some embodiments may obtain a set of vehicle characterization parameters based on the vehicle data or vehicle utilization parameters, as indicated by block 420. Some embodiments may obtain a set of vehicle characterization parameters by computing the set of vehicle characterization parameters using operations similar to or the same as those described by block 316. For example, some embodiments may obtain a vector representing the parameters of a vector autoregression model. Alternatively, or in addition, some embodiments may obtain a vehicle characterization parameter by retrieving a stored vehicle characterization parameter based on a vehicle type. For example, some embodiments may obtain a set of neural network parameters stored in a database in association with a vehicle type, where some embodiments may obtain different sets of neural network parameters based on vehicle categories and utilization parameters.

Some embodiments may determine a set of vehicle degradation values based on the set of vehicle characterization values, as indicated by block 430. The set of vehicle degradation values may include values associated with mechanical or electrical components of a vehicle, such as indicated likelihood of mechanical component failure or electrical component failure. In some embodiments, the set of vehicle degradation values may be specific to a mechanical or electrical component. Alternatively, or in addition, the set of vehicle degradation values may include values indicating a likelihood of a general mechanical or electrical failure. For example, some embodiments may predict a likelihood of any mechanical failure that would prevent a vehicle from being mobile based on a corresponding set of vehicle characterization values, vehicle utilization parameters, and a specific set of sensor measurements for a vehicle.

Various forecasting models, other types of statistical prediction models, or learning models may be used to determine a set of vehicle degradation values. For example, some embodiments may use a vector autoregressive time series model to determine a vehicle degradation value such as a likelihood of equipment failure, where parameters or inputs to the model are correlated with or otherwise based on the set of vehicle characterization values, vehicle utilization parameters, and a specific set of sensor measurements. Alternatively, or in addition, some embodiments may use a neural network or another learning model to determine the set of vehicle degradation values based on vehicle characterization values comprising neural network parameters. Furthermore, some embodiments may filter parameters, model inputs, or other values of a forecasting model, machine learning model, or other prediction model based on a set of user inputs. For example, some embodiments may select a first set of utilization parameters as inputs for a forecasting model in lieu of a second set of utilization parameters for the forecasting model based on a determination that a set of user inputs includes a first set of values, does not include a second set of values, or includes a numeric value that satisfies a threshold.

Alternatively, or in addition, the set of vehicle degradation values may include sales prices for vehicles, monthly payment values, depreciation values, etc. For example, some embodiments may predict a set of vehicle resale prices at different time points for different makes/models of vehicles. Some embodiments may use vehicle utilization parameters as inputs or weighting factors when determining changes in the set of vehicle degradation values. For example, some embodiments may use a machine learning model that will receive, as an input, an expected daily travel distance for a vehicle, and expected weight that the vehicle is required to carry, a set of vehicle characterization parameters associated with a vehicle category of the vehicle, and output a vehicle degradation value, such as a depreciation value.

Some embodiments may select a set of vehicles based on the set of vehicle degradation values, as indicated by block 440. In some embodiments, a vehicle may be selected from a set of available vehicles, where each of the available vehicles may be determined to be available based on one or more sensor measurements. For example, vehicles of a managed fleet may send one or more messages to a set of servers or another set of computing devices that may then be used to update a list of available vehicles. Alternatively, or in addition, the set of available vehicles may be obtained from a database or third-party data source. For example, some embodiments may obtain a list of available vehicles from a database of cars that are for sale in a geographic region.

In some embodiments, a threshold used to select the set of vehicles may be based on demographic information, user-specific financial information, or other user-specific scores. For example, some embodiments may determine a payment threshold equal to or based on a product of a stored income of a user and a rate value. Some embodiments may then select a vehicle based on a determination that a maintenance cost and monthly payment price associated with a vehicle satisfies the payment threshold.

In some embodiments, the selected vehicle or another vehicle of a set of available vehicles may also be a vehicle that contributed to the vehicle data used to determine the vehicle characterization parameters. For example, a selected vehicle having a vehicle record may include a set of sales prices for the vehicle, odometer measurements from the vehicle, and ODB sensor data from the vehicle, where the vehicle record may have been used in conjunction with data from other vehicle records to determine a vehicle characterization parameter. Alternatively, the selected vehicle or another vehicle of the set of available vehicles may be different from the vehicles associated with the vehicle data used to determine the vehicle characterization parameters.

Some embodiments may send a message to a selected vehicle or a client computer device based on the selected vehicle, as indicated by block 450. Some embodiments may send instructions or data to a selected vehicle via a wireless message. For example, some embodiments may send destination data to a vehicle, where an onboard computing device of the vehicle may then use the destination to generate a navigation path from a current location of the vehicle to the destination. Alternatively, some embodiments may send an identifier of the selected vehicle to a client computer device. For example, some embodiments may send a vehicle name of the selected vehicle and an image of the selected vehicle to a smartphone device.

Some embodiments may send a message or client computer device to a vehicle for specific issues associated with a set of thresholds. For example, some embodiments may determine a vehicle status based on a time series of the vehicle using a time series model. As described elsewhere in this disclosure, the time series may include vehicle sensor data, other vehicle event data, or other sequences of scores associated with the vehicle. Some embodiments may then send a message indicating the vehicle status to the vehicle. Alternatively, or in addition, some embodiments may send a message that includes a value that, upon receipt by the vehicle, causes the vehicle to determine that a threshold is satisfied by the value. In some embodiments, the vehicle may include onboard computing resources that may use neural network models to determine predictions. For example, in some embodiments, a vehicle may receive a vehicle status or a set of values associated with the vehicle status. The vehicle may then provide the vehicle status or set of values in conjunction with a set of vehicle sensor measurements of the vehicle to a machine learning model to determine an output. Some embodiments may then determine whether the output satisfies a threshold. The threshold may include a safety threshold that indicates that a safety parameter has been violated, a performance threshold indicating that the vehicle is performing below an expected energy efficiency, a degradation threshold indicating a depreciation value, etc. In response to a determination that the output is satisfied, the vehicle may be caused to display a notification on a visual display of the vehicle, such as an in-vehicle notification screen.

Some embodiments may perform one or more operations described above to select a plurality of vehicles, where each vehicle may be selected based on their corresponding vehicle degradation values or another type of value correlated with the vehicle degradation value. In some embodiments, the vehicles may be selected from a set of available vehicles, where the available vehicles are indicated as available for purchase. For example, some embodiments may select ten different vehicles based on a determination that a threshold is satisfied by each respective value of the respective vehicle of the ten vehicles, where the respective value may include a monthly payment price, monthly maintenance price, expected total cost, expected depreciation value, etc. Some embodiments may list the plurality of vehicles in an order based on their vehicle degradation values or other values associated with the vehicle degradation values in a user interface that is displayed on a client computer device. Listing the vehicles may include identifiers of the vehicles, listing images of the vehicles, list descriptions of the vehicles, etc. For example, some embodiments may list vehicle names and vehicle images in a user interface in order of their lowest expected rate of failure over a one-year period. Alternatively, or in addition, some embodiments may list vehicles in a user interface in order of their lowest expected costs, where the costs may include the monthly cost of payment, the cost of vehicle maintenance, the total cost of a vehicle, etc. Furthermore, some embodiments may display the list of vehicles in an interactive form, such that a user may click or tap on an image of a vehicle and be provided to a link to purchase the vehicle or obtain financial information related to the vehicle.

Alternatively, or in addition, some embodiments may update a record associated with a selected vehicle indicating a status change that modifies one or more utilization parameters of the selected vehicle. For example, some embodiments may determine whether a vehicle degradation value is indicated to satisfy a threshold at a first time point. Based on a determination that the vehicle degradation value satisfies the threshold, some embodiments may change a vehicle status associated with the vehicle. In some embodiments, a change in the vehicle status may modify the utilization parameters that the vehicle is indicated as capable of satisfying, where the modified set of utilization parameters may include fewer parameters, more parameters, or different parameters. For example, a vehicle status for a vehicle may be changed from a “heavy use vehicle” to “light use vehicle,” where the maximum allocated weight for a truck may be changed from three tons to one ton. Alternative, or in addition, some embodiments may provide the vehicle with a destination of a navigation path associated with “light use” vehicles. After the status change, an alternative vehicle may be allocated to tasks previously allocated to the selected vehicle, where destinations of navigation paths previously sent to the selected vehicle may be sent to the alternative vehicle.

In some embodiments, operations described in this disclosure may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a non-transitory, machine-readable medium, such as an electronic storage medium. The processing devices may include one or more devices configured through hardware, firmware, and/or software to be specifically designed for execution of one or more of the operations of the methods. For example, it should be noted that any of the devices or equipment discussed in relation to FIGS. 1-2 could be used to perform one or more of the operations in FIGS. 3-4.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 may include one or more computing devices that are programmed to perform the functions described herein. The computing devices may include one or more types of electronic storage medium (e.g., the set of databases 130), one or more physical processors programmed with one or more computer program instructions, and/or other components. The computing devices may include communication lines or ports to enable the exchange of information with a set of networks (e.g., network 150) or other computing platforms via wired or wireless techniques. The network may include the Internet, a mobile phone network, a mobile voice or data network (e.g., a 5G or Long-Term Evolution (LTE) network), a cable network, a public switched telephone network, or other types of communications networks or combinations of communications networks. The network 150 may include one or more communications paths, such as Ethernet, a satellite path, a fiber-optic path, a cable path, a path that supports Internet communications (e.g., IPTV), free-space connections (e.g., for broadcast or other wireless signals), WiFi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storage. The electronic storage may include non-transitory storage media that electronically stores information. The storage media of the electronic storage may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). An electronic storage may store software algorithms, information determined by the processors, information obtained from servers, information obtained from client devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 124-127 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 124-127 described herein is for illustrative purposes, and is not intended to be limiting, as any of subsystems 124-127 may provide more or less functionality than is described. For example, one or more of subsystems 124-127 may be eliminated, and some or all of the functionality of such subsystem(s) may be provided by other ones of subsystems 124-127. As another example, additional subsystems may be programmed to perform some or all of the functionality attributed herein to one of subsystems 124-127.

With respect to the components of computer devices described in this disclosure, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Further, some or all of the computer devices described in this disclosure may include a user input interface and/or user output interface (e.g., a display) for use in receiving and displaying data. In some embodiments, a display such as a touchscreen may also act as user input interfaces. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “the element” includes a combination of two or more elements, notwithstanding use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., one or more processors performing steps/operations A, B, C, and D) encompass both or all such attributes or functions being mapped to all such objects and subsets of the attributes or functions being mapped to subsets of the objects (e.g., both or all processors each performing steps/operations A-D, and in a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection have some property should not be read to exclude cases where some otherwise identical or similar members of a larger collection do not have the property (i.e., each does not necessarily mean each and every). Limitations as to sequence of recited steps should not be read into the claims unless explicitly specified (e.g., with explicit language like “after performing X, performing Y”) in contrast to statements that might be improperly argued to imply sequence limitations, (e.g., “performing X on items, performing Y on the X'ed items”) used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification, discussions utilizing terms, such as “processing,” “computing,” “calculating,” “determining,” or the like refer to actions or processes of a specific apparatus, such as a special purpose computer or a similar special purpose electronic processing/computing device. Furthermore, unless indicated otherwise, updating an item may include generating the item or modifying an existing time. Thus, updating a record may include generating a record or modifying the value of an already-generated value.

### ENUMERATED EMBODIMENTS

The present techniques will be better understood with reference to the following enumerated embodiments:

1. A method comprising: obtaining vehicle records associated with a plurality of vehicles; obtaining a set of utilization parameters; determining a plurality of values associated with the plurality of vehicles based on the set of utilization parameters and a vehicle record of the vehicle records; and selecting a first vehicle of the plurality of vehicles based on a value associated with the first vehicle.
2. The method of embodiment 1, wherein determining the plurality of values comprises determining the plurality of values by, for each available vehicle of the plurality of vehicles, determining a value of the plurality of values for the available vehicle based on the set of utilization parameters, the vehicle record associated with a vehicle category of the available vehicle, and a record value of the available vehicle.
3. The method of embodiments 1-2, further comprising providing instructions to an application in communication with the first vehicle in response to the selection of the first vehicle.
4. A method for selecting a vehicle based on utilization parameters for fulfilling a destination-related task comprising: obtaining vehicle sensor measurements of a plurality of vehicles to generate vehicle records associated with the plurality of vehicles, each subset of measurements of the vehicle sensor measurements comprising an odometer measurement of a respective vehicle of the plurality of vehicles; obtaining a set of vehicle utilization parameters comprising a transportation weight parameter and a navigation path; for each available vehicle of the plurality of vehicles, determining vehicle degradation values for the available vehicle based on (i) the set of vehicle utilization parameters, (ii) the vehicle record associated with a vehicle category of the available vehicle, and (iii) the odometer measurement of the available vehicle; and selecting a first vehicle over one or more other vehicles of the plurality of vehicles based on the vehicle degradation value for the first vehicle; in response to the selection of the first vehicle, wirelessly providing a destination of the navigation path to an application of the first vehicle.
5. A method comprising obtaining vehicle sensor measurements of a plurality of vehicles to generate vehicle records associated with the plurality of vehicles; obtaining a set of vehicle utilization parameters comprising a transportation weight parameter and distance; determining a plurality of values associated with the plurality of vehicles by, for each available vehicle of the plurality of vehicles, determining a value of the plurality of vehicles for the available vehicle based on the set of vehicle utilization parameters, the vehicle record associated with a vehicle category of the available vehicle, and a sensor measurement of the available vehicle; and selecting a first vehicle over one or more other vehicles of the plurality of vehicles based on a value of the values associated with the first vehicle; in response to the selection of the first vehicle, wirelessly providing instructions to an application in communication with the first vehicle.
6. The method of any of embodiments 1 to 5, wherein the vehicle degradation value is a first vehicle degradation value, and wherein a set of vehicle degradation values comprises the first vehicle degradation value and is associated with the first vehicle, wherein the navigation path is a first navigation path, the method further comprising: predicting a time point for when the set of vehicle degradation values satisfies a threshold based on a subset of records sharing a vehicle category of the first vehicle; in response to a determination that the set of vehicle degradation values satisfies the threshold, updating the set of vehicle degradation values based on a second navigation path; selecting a second vehicle based on the updated set of vehicle degradation values; and wirelessly providing a destination of the second navigation path to the second vehicle.
7. The method of any of embodiments 1 to 6, wherein obtaining the set of vehicle utilization parameters comprises: obtaining a set of locations and set of entities via a set of user inputs from a client computer device; obtaining the transportation weight parameter based on a count of the set of entities; and obtaining the navigation path based on the set of locations.
8. The method of any of embodiments 1 to 7, further comprising: selecting a plurality of vehicle categories based on the set of vehicle utilization parameters, wherein each respective category of the plurality of vehicle categories is associated with a respective set of features that comprises the set of vehicle utilization parameters; obtaining the vehicle records based on the plurality of vehicle categories; and causing a display of identifiers of the plurality of vehicle categories in the application, wherein the identifiers are displayed in an order based on the set of vehicle degradation values.
9. The method of any of embodiments 1 to 8, wherein obtaining the vehicle sensor measurements comprises: obtaining a sequence of sensor measurements of a second vehicle, wherein the plurality of vehicles comprises the second vehicle; modifying timestamps of the sequence of sensor measurements without modifying an order of the sequence of sensor measurements; and updating the vehicle sensor measurements based on the modified sequence of sensor measurements.
10. The method of any of embodiments 1 to 9, wherein the value is a first value that is stored in a first vehicle record associated with the first vehicle, the method further comprising: determining whether the first value satisfies a threshold; in response to a determination that the first value satisfies the threshold, obtaining a first utilization parameter, wherein the set of vehicle utilization parameters does not comprise the first utilization parameter; and updating a record associated with the first vehicle indicating a status change of the first vehicle based on the first utilization parameter.
11. The method of any of embodiments 1 to 10, the method further comprising: selecting a second vehicle of the plurality of vehicles based on a determination that the second vehicle and the first vehicle share a set of vehicle features and that a value associated with the second vehicle does not satisfy the threshold; and updating a record of the second vehicle to comprise the set of vehicle utilization parameters.
12. The method of any of embodiments 1 to 11, the method further comprising: wherein obtaining the vehicle sensor measurements comprises obtaining a plurality of time series, wherein each time series of the plurality of time series is associated with a respective vehicle of the plurality of vehicles; determining a vehicle status of the first vehicle based on a time series of the plurality of time series, wherein the time series is associated with the first vehicle; sending the vehicle status to the vehicle, wherein a vehicle computer system performs operations comprising: providing the vehicle status and a set of vehicle sensor measurements to a machine learning model to obtain an output; determining whether the output satisfies a threshold; and displaying a notification on a visual display of the vehicle in response to a determination that the output satisfies the threshold.
13. The method of any of embodiments 1 to 12, the method further comprising: obtaining a maintenance history of the first vehicle; obtaining a selling price of the first vehicle; and determining a set of sequences of events based on the maintenance history by populating the set of sequences of events with events, wherein: an event of the sequences of events is selected based on words of the maintenance history; and determining values for the plurality of vehicles comprises generating a sequence of scores based on the set of sequences of events, wherein the sequence of scores is associated with the first vehicle.
14. The method of any of embodiments 1 to 13, and wherein obtaining the values comprises: selecting a user record listed in association with the first vehicle; obtaining a transaction record associated with the user record, wherein the transaction record indicates a change in a score of the record, a date associated with the change, and a string associated with the change; selecting the transaction record based on the string; determining an event of a sequence of events associated with the first vehicle based on the change in the score and the date associated with the change.
15. The method of any of embodiments 1 to 14, wherein selecting the transaction record based on the string comprises: determining a product identifier based on the transaction record; determining whether the product identifier is compatible with the first vehicle by: sending the product identifier and the vehicle category to a second set of servers via an application program interface; receiving a response from the second set of servers indicating whether the product identifier is compatible with the first vehicle; and wherein determining the event comprises determining the event in response to a determination that the product identifier is compatible with the first vehicle based on a numeric value associated with the transaction record.
16. The method of any of embodiments 1 to 15, wherein determining the plurality of values comprises: obtaining a time series of scores associated with the first vehicle; and determining the value associated with the first vehicle based on the time series using a time series model.
17. The method of any of embodiments 1 to 16, wherein determining the plurality of values comprises: obtaining a sequence of sensor measurements of the first vehicle; modifying times of the sequence of the sensor measurements without modifying an order of the sequence of the sensor measurements; and wherein determining the plurality of values comprises determining the value of the first vehicle based on the modified sequence of the sensor measurements.
18. The method of any of embodiments 1 to 17, wherein obtaining the vehicle records comprises: obtaining a sequence of tokens from a record associated with a date using a machine learning model; determining an event code based on the sequence of tokens; associating the event code to the date in the vehicle records, wherein determining the plurality of values comprises determining the value associated with the first vehicle based on the event code.
19. The method of any of embodiments 1 to 18, wherein determining the event code based on the sequence of tokens comprises: generating a set of vectors corresponding with the sequence of tokens using a first neural network and a geographic location associated with the record; and determining the event code based on the set of vectors.
20. The method of any of embodiments 1 to 19, the method further comprising: selecting a user record listed in association with the first vehicle; receiving a set of inputs from a user identified by the user record, wherein the set of inputs comprises a duration; segmenting the duration into a sequence of time segments; and determining a sequence of utilization parameters based on the set of inputs, by predicting a utilization parameter of the sequence of utilization parameters based on the user record and the set of inputs using on a probabilistic model, wherein each utilization parameter of the sequence of utilization parameters is associated with a time segment of the sequence of time segments; and wherein determining the plurality of values comprises, for each respective time segment of the sequence of time segments, determining a respective value of the set of values associated with the first vehicle based on a respective utilization parameter of the sequence of utilization parameters, wherein the respective utilization parameter is associated with the respective time segment.
21. The method of any of embodiments 1 to 20, the method further comprising: selecting a user record listed in association with the first vehicle; obtaining a set of numeric scores stored in association with the user record; and determining a threshold based on the set of numeric scores, wherein selecting the first vehicle comprises determining whether the value of the first vehicle satisfies the threshold.
22. The method of any of embodiments 1 to 21, the method further comprising: obtaining a set of user inputs from a client computer device, wherein the set of user inputs comprises a first vehicle feature set and a numeric value representing a number of people; determining a second vehicle feature set based on the numeric value; determining a vehicle feature superset based on the first vehicle feature set and the second vehicle feature sets, wherein obtaining the set of vehicle utilization parameters comprises determining the set of vehicle utilization parameters based on the vehicle feature superset.
23. The method of any of embodiments 1 to 22, the method further comprising obtaining a set of user inputs from a client computer device, wherein the value associated with the first vehicle is a first value, wherein determining the plurality of values comprises determining the first value, and wherein determining the first value comprises: obtaining a plurality of record values associated with a vehicle record of the first vehicle; filtering the set of utilization parameters based on the set of user inputs; and determining the first value based on the filtered set of utilization parameters using a forecasting model.
24. One or more tangible, non-transitory, machine-readable media storing instructions that, when executed by one or more processors, effectuating operations comprising those of any of embodiments 1-23.
25. A system comprising: one or more processors; and memory storing computer program instructions that, when executed by the one or more processors, cause the one or more processors to effectuate operations comprising those of any of embodiments 1-23.

What is claimed is:

1. A method for selecting a vehicle based on utilization parameters for fulfilling a destination-related task comprising:
obtaining vehicle sensor measurements of a plurality of vehicles to generate vehicle records associated with the plurality of vehicles, each subset of measurements of the vehicle sensor measurements comprising an odometer measurement of a respective vehicle of the plurality of vehicles;
obtaining a set of vehicle utilization parameters comprising a transportation weight parameter and a navigation path;
for each available vehicle of the plurality of vehicles, determining vehicle degradation values for the available vehicle based on (i) the set of vehicle utilization parameters, (ii) the vehicle record associated with a vehicle category of the available vehicle, and (iii) the odometer measurement of the available vehicle;
selecting a first vehicle over one or more other vehicles of the plurality of vehicles based on the vehicle degradation value for the first vehicle; and
in response to the selection of the first vehicle, wirelessly providing a destination of the navigation path to an application of the first vehicle.

2. The method of claim 1, wherein the vehicle degradation value is a first vehicle degradation value, and wherein a set of vehicle degradation values comprises the first vehicle degradation value and is associated with the first vehicle, wherein the navigation path is a first navigation path, the method further comprising:
predicting a time point for when the set of vehicle degradation values satisfies a threshold based on a subset of records sharing a vehicle category of the first vehicle;
in response to a determination that the set of vehicle degradation values satisfies the threshold, updating the set of vehicle degradation values based on a second navigation path;
selecting a second vehicle based on the updated set of vehicle degradation values; and
wirelessly providing a destination of the second navigation path to the second vehicle.

3. The method of claim 1, wherein obtaining the set of vehicle utilization parameters comprises:
obtaining a set of locations and set of entities via a set of user inputs from a client computer device;
obtaining the transportation weight parameter based on a count of the set of entities; and
obtaining the navigation path based on the set of locations.

4. The method of claim 1, further comprising:
selecting a plurality of vehicle categories based on the set of vehicle utilization parameters, wherein each respective category of the plurality of vehicle categories is associated with a respective set of features that comprises the set of vehicle utilization parameters;
obtaining the vehicle records based on the plurality of vehicle categories; and
causing a display of identifiers of the plurality of vehicle categories in the application, wherein the identifiers are displayed in an order based on the set of vehicle degradation values.

5. The method of claim 1, wherein obtaining the vehicle sensor measurements comprises:
obtaining a sequence of sensor measurements of a second vehicle, wherein the plurality of vehicles comprises the second vehicle;
modifying timestamps of the sequence of sensor measurements without modifying an order of the sequence of sensor measurements; and
updating the vehicle sensor measurements based on the modified sequence of sensor measurements.

6. A tangible, non-transitory, machine-readable media storing instructions that, when executed by one or more processors, effectuating operations comprising:
obtaining vehicle sensor measurements of a plurality of vehicles to generate vehicle records associated with the plurality of vehicles;
obtaining a set of vehicle utilization parameters comprising a transportation weight parameter and distance;
determining a plurality of values associated with the plurality of vehicles by, for each available vehicle of the plurality of vehicles, determining a value of the plurality of vehicles for the available vehicle based on the set of vehicle utilization parameters, the vehicle record associated with a vehicle category of the available vehicle, and a sensor measurement of the available vehicle;
selecting a first vehicle over one or more other vehicles of the plurality of vehicles based on a value of the values associated with the first vehicle; and
in response to the selection of the first vehicle, wirelessly providing instructions to an application in communication with the first vehicle.

7. The media of claim 6, wherein the value is a first value that is stored in a first vehicle record associated with the first vehicle, the operations further comprising:
determining whether the first value satisfies a threshold;
in response to a determination that the first value satisfies the threshold, obtaining a first utilization parameter, wherein the set of vehicle utilization parameters does not comprise the first utilization parameter; and
updating a record associated with the first vehicle indicating a status change of the first vehicle based on the first utilization parameter.

8. The media of claim 7, the operations further comprising:
selecting a second vehicle of the plurality of vehicles based on a determination that the second vehicle and the first vehicle share a set of vehicle features and that a value associated with the second vehicle does not satisfy the threshold; and
updating a record of the second vehicle to comprise the set of vehicle utilization parameters.

9. The media of claim 6, the operations further comprising:
wherein obtaining the vehicle sensor measurements comprises obtaining a plurality of time series, wherein each time series of the plurality of time series is associated with a respective vehicle of the plurality of vehicles;
determining a vehicle status of the first vehicle based on a time series of the plurality of time series, wherein the time series is associated with the first vehicle;
sending the vehicle status to the vehicle, wherein a vehicle computer system performs operations comprising:
providing the vehicle status and a set of vehicle sensor measurements to a machine learning model to obtain an output;
determining whether the output satisfies a threshold; and
displaying a notification on a visual display of the vehicle in response to a determination that the output satisfies the threshold.

10. The media of claim 6, the operations further comprising:
obtaining a maintenance history of the first vehicle;
obtaining a selling price of the first vehicle; and
determining a set of sequences of events based on the maintenance history by populating the set of sequences of events with events, wherein:
an event of the sequences of events is selected based on words of the maintenance history; and
determining values for the plurality of vehicles comprises generating a sequence of scores based on the set of sequences of events, wherein the sequence of scores is associated with the first vehicle.

11. The media of claim 10, and wherein obtaining the values comprises:
selecting a user record listed in association with the first vehicle;
obtaining a transaction record associated with the user record, wherein the transaction record indicates a change in a score of the record, a date associated with the change, and a string associated with the change;
selecting the transaction record based on the string; and
determining an event of a sequence of events associated with the first vehicle based on the change in the score and the date associated with the change.

12. The media of claim 11, wherein selecting the transaction record based on the string comprises:
determining a product identifier based on the transaction record;
determining whether the product identifier is compatible with the first vehicle by:
sending the product identifier and the vehicle category to a second set of servers via an application program interface;
receiving a response from the second set of servers indicating whether the product identifier is compatible with the first vehicle; and
wherein determining the event comprises determining the event in response to a determination that the product identifier is compatible with the first vehicle based on a numeric value associated with the transaction record.

13. A system comprising:
one or more processors; and
memory storing computer program instructions that, when executed by the one or more processors, cause the one or more processors to effectuate operations comprising:
obtaining vehicle records associated with a plurality of vehicles;
obtaining a set of utilization parameters;
determining a plurality of values associated with the plurality of vehicles by, for each available vehicle of the plurality of vehicles, determining a value of the plurality of values for the available vehicle based on the set of utilization parameters, the vehicle record associated with a vehicle category of the available vehicle, and a record value of the available vehicle; and
selecting a first vehicle of the plurality of vehicles based on a value associated with the first vehicle; and
in response to the selection of the first vehicle, providing instructions to an application in communication with the first vehicle.

14. The system of claim 13, wherein determining the plurality of values comprises:
obtaining a time series of scores associated with the first vehicle; and
determining the value associated with the first vehicle based on the time series using a time series model.

15. The system of claim 13, wherein determining the plurality of values comprises:
obtaining a sequence of sensor measurements of the first vehicle;
modifying times of the sequence of the sensor measurements without modifying an order of the sequence of the sensor measurements; and
wherein determining the plurality of values comprises determining the value of the first vehicle based on the modified sequence of the sensor measurements.

16. The system of claim 13, wherein obtaining the vehicle records comprises:
obtaining a sequence of tokens from a record associated with a date using a machine learning model;
determining an event code based on the sequence of tokens; and
associating the event code to the date in the vehicle records, wherein determining the plurality of values comprises determining the value associated with the first vehicle based on the event code.

17. The system of claim 16, wherein determining the event code based on the sequence of tokens comprises:
generating a set of vectors corresponding with the sequence of tokens using a first neural network and a geographic location associated with the record; and
determining the event code based on the set of vectors.

18. The system of claim 13, the operations further comprising:
selecting a user record listed in association with the first vehicle;
receiving a set of inputs from a user identified by the user record, wherein the set of inputs comprises a duration;
segmenting the duration into a sequence of time segments;
determining a sequence of utilization parameters based on the set of inputs, by predicting a utilization parameter of the sequence of utilization parameters based on the user record and the set of inputs using on a probabilistic model, wherein each utilization parameter of the sequence of utilization parameters is associated with a time segment of the sequence of time segments; and
wherein determining the plurality of values comprises, for each respective time segment of the sequence of time segments, determining a respective value of the set of values associated with the first vehicle based on a respective utilization parameter of the sequence of utilization parameters, wherein the respective utilization parameter is associated with the respective time segment.

19. The system of claim 13, the operations further comprising:
selecting a user record listed in association with the first vehicle;
obtaining a set of numeric scores stored in association with the user record; and
determining a threshold based on the set of numeric scores, wherein selecting the first vehicle comprises determining whether the value of the first vehicle satisfies the threshold.

20. The system of claim 13, the operations further comprising:
obtaining a set of user inputs from a client computer device, wherein the set of user inputs comprises a first vehicle feature set and a numeric value representing a number of people;
determining a second vehicle feature set based on the numeric value; and
determining a vehicle feature superset based on the first vehicle feature set and the second vehicle feature sets, wherein obtaining the set of vehicle utilization parameters comprises determining the set of vehicle utilization parameters based on the vehicle feature superset.
